(19) United States
(12) Patent Application Publication
(10) Pub. No.: US 2021/0189210 A1
(43) Pub. Date: Jun. 24, 2021

(54) MIXTURES OF MD-METHYLPOLYSILOXANES AS HEAT CARRIER FLUID

(71) Applicant: WACKER CHEMIE AG, Munich (DE)

(72) Inventors: Steffen DOERRICH, Munich (DE); Erich SCHAFFER, Duttendorf (AT); Harald VOIT, Reischach (DE); Richard WEIDNER, Burghausen (DE)

(73) Assignee: WACKER CHEMIE AG, Munich (DE)

(21) Appl. No.: 16/755,823

(22) PCT Filed: Oct. 13, 2017
(86) PCT No.: PCT/EP2017/076258

§ 371 Date: Apr. 13, 2020

(51) Int. Cl. C09K 5/10; C08G 77/04; F24S 80/20

(52) U.S. Cl. CPC C09K 5/10; C08G 77/70; F24S 80/20; C08G 77/04

(57) ABSTRACT

Silicone heat transfer fluids having a narrow range of M:D units and a specified proportion of cyclic siloxanes are able to be used at heat transfer fluids at high temperatures without reaching a supercritical state.

### CROSS REFERENCE TO RELATED APPLICATIONS

This application is the U.S. National Phase of PCT Appln. No. PCT/EP2017/076258 filed Oct. 13, 2017, the disclosure of which is incorporated in its entirety by reference herein.

### BACKGROUND OF THE INVENTION

### 1. Field of the Invention

The present invention relates to methylpolysiloxane mixtures having a molar M:D ratio from 1:5.5 to 1:15 and 25 to 55% by mass cyclic methylpolysiloxanes, and to the use thereof as a heat carrier fluid.

### 2. Description of the Related Art

Organosiloxanes, especially methylpolysiloxane mixtures, are frequently used as heat transfer fluids due to their high thermal stability, their broad liquid range and the low temperature dependency of their viscosity. WO 2014/001081 describes methylpolysiloxane mixtures which are suitable as heat transfer fluids for high temperatures (HTF). The numerical ratio of the Me₃Si chain end groups (M) to the sum total of Me₂SiO units (D) in the methylpolysiloxane mixtures is at least 1:2 and at most 1:10.

Measurements have shown that methylpolysiloxane mixtures having an M:D ratio of 1:4, which are currently used as HTFs below the desired maximum operating temperature of 425° C., transform into the supercritical state. This has a negative effect on the performance of the HTF, since the heat transfer properties of the HTF become poorer due to the transition to the supercritical range. For instance, the heat capacity or even the density declines. Table 1 shows that the density declines due to the transition to the supercritical state between 399.6 and 450° C.

TABLE 1
Density curve of equilibrated methylpolysiloxane mixture having
M:D = 1:4 (bold font = not supercritical; standard font = supercritical)

| T [° C.] | ρ [g/cm³] |
|---|---|
| 27.4 | 0.9097 |
| 49.7 | 0.8914 |
| 99.9 | 0.8424 |
| 149.7 | 0.7961 |
| 199.8 | 0.7463 |
| 250.8 | 0.6963 |
| 299.7 | 0.6334 |
| 350.1 | 0.5465 |
| 399.6 | 0.4299 |
| 450.0 | 0.1999 |

U.S. Pat. No. 3,694,405, example 17 describes the equilibration of a methylpolysiloxane mixture having a molar M:D ratio of 1:5.3.

### SUMMARY OF THE INVENTION

The invention relates to a methylpolysiloxane mixture comprising methylpolysiloxanes having Me₃Si chain end groups (M) and Me₂SiO units (D), wherein the molar M:D ratio in the methylpolysiloxane mixture is from 1:5.5 to 1:15 and the sum total of the proportions of all cyclic methylpolysiloxanes is 25 to 55% by mass.

### DETAILED DESCRIPTION OF THE PREFERRED EMBODIMENTS

The causal factor for the position of the critical point of a methylpolysiloxane mixture is the molecular composition. Methylpolysiloxanes having relatively low molar masses, especially linear methylpolysiloxanes MM (Si2), MDM (Si3), MDDM (Si4), etc. . . . and cyclic methylpolysiloxanes D3, D4, D5, etc transform into the supercritical state at a relatively low temperature (see Table 2).

TABLE 2
Selected pure substance data of linear and cyclic siloxanes
(data base ASPEN DB-PURE28) (up to Si8 and up to D8,
the critical temperature is below the desired operating
temperature of the heat transfer oil of 425° C.)

| | | Si atoms (linear) | | | | |
|---|---|---|---|---|---|---|
| | | 2 | 44 | 6 | 8 | 12 |
| Critical | [° C.] | 245.8 | 326.8 | 380.05 | 415.8 | 478.2 |
| temperature | | | | | | |

| | D unit4es (cyclic) | | | | |
|---|---|---|---|---|---|
| | 3 | 4 | 5 | 6 | 8 |
| [° C.] | 281.1 | 313.4 | 346.0 | 372.7 | 416.1 |

Under thermal stress, linear endstopped methylpolysiloxanes rearrange, they equilibrate. Irrespective of the starting composition, the result is a methylpolysiloxane mixture of linear siloxanes (Si2, Si3, Si4, etc. . . . ) and cyclic siloxanes (D3, D4, D5, etc. . . . ), which is in thermal thermodynamic equilibrium. The thermal equilibrium position results from the maximum operating temperature to which the methylpolysiloxane is exposed, and from the molar M:D ratio of the methylpolysiloxane mixture. The equilibrium position depends on the temperature. At high temperatures, such as 425° C. for example, equilibrium is reached within 1-2 months (sustained load). At lower temperatures, another equilibrium is reached; at 400° C., however establishment of equilibrium even takes 2-4 months. Therefore, in actual operation of a heat transfer fluid, especially in CSP power plant operation, equilibrium is always reached after some time at the highest maximum operating temperature, since the rate constant for achieving equilibrium at a higher temperature is greater than the rate constant for achieving equilibrium at a lower temperature (corresponds to reverse reaction/reequilibration). In addition, the residence time of the heat transfer oil in actual CSP power plant operation at maximum operating temperature is higher (receiver end to evaporator), and the heat transfer oil is very rapidly cooled to 300° C. in the evaporator. At 300° C., equilibration establishes only extremely slowly.

Surprisingly, it has been found that a methylpolysiloxane mixture according to the invention having a molar M:D ratio from 1:5.5 to 1:15, preferably 1:5.6 to 1:10.5, especially 1:5.8 to 1:9, in the equilibrated state, has a composition (see Table 3) that does not transform into the supercritical state up to 425° C. (see Table 4).

In a preferred embodiment, 46 to 65% by mass, preferably 50 to 60% by mass, and especially 52 to 58% by mass of the methylpolysiloxanes in the methylpolysiloxane mixture are selected from methylpolysiloxanes Siₓ where x>8 and D_{y} where y>8.

Due to the problems described above on transition to the supercritical state, when using methylpolysiloxanes as heat transfer oils at a desired application temperature of 425° C., it is advisable to use only methylpolysiloxanes having a molar M:D ratio of at least 1:5.5, preferably 5.6, especially 5.8. In addition, from an application point of view, also no methylpolysiloxanes with too high a molar M:D ratio should be used, since this means that the average chain length of the heat transfer fluid, and thus also the viscosity, increases. This has negative effects on the operation of a heat transfer system since as a result, inter alia, the circulation of the heat transfer fluid can only be achieved with relatively high pump capacity. It is also known and described in DE102014209670 and DE102015202158 that the shelf-life of an Si-HTF is determined by the formulation of trifunctional siloxane units, so-called T units. The molecules of the HTF crosslink through the branchings formed, which means the viscosity of the Si-HTF increases and eventually it can no longer be pumped. The longer-chain or high molecular weight an MD-Si-HTF (i.e. the higher the molar M:D ratio), the fewer branching T units have to be formed thermally in order to crosslink the HTF molecules with one another. Therefore, the sensible economical use of high-temperature Si-HTFs is limited to a maximum molar M:D ratio of 1:15.

The arithmetic mean of x (preferably determined in analogy to the gas chromatographic method described below), weighted by proportions by mass, over all linear methylpolysiloxanes (Siₓ) from Si2 to Si22 is preferably between 2.3 and 3.6, more preferably between 2.5 and 3.5.

The arithmetic mean of y (preferably determined in analogy to the gas chromatographic method described below), weighted by proportions by mass, over all cyclic methylpolysiloxanes (Si_{y}) from D3 to D17 is preferably between 1.7 and 3.5, more preferably between 1.9 and 3.1.

Preferably, the sum total of the proportions (preferably determined in analogy to the gas chromatographic method described below) of all cyclic methylpolysiloxanes is at least 26% by mass and at most 50% by mass, more preferably at least 27% by mass and at most 32% by mass.

The viscosity of the methylpolysiloxane mixture according to the invention at 25° C. is preferably below 50 mPa*s, more preferably below 20 mPa*s, and especially between 5 and 15 mPa*s.

The methylpolysiloxane mixture can be present in a monomodal, bimodal or multimodal distribution (determined in analogy to the gas chromatographic method described below and according to applied retention times), and at the same time the distribution can be narrow or broad. The methylpolysiloxane mixture according to the invention preferably has a bimodal, trimodal or multimodal distribution. The methylpolysiloxane mixture more preferably has a multimodal distribution at 425° C. Considering the distribution of the linear siloxanes and the cyclic siloxanes separately in each case results in a monomodal distribution.

The methylpolysiloxane mixture according to the invention preferably comprises less than 500 ppm water, more preferably less than 200 ppm water, and especially less than 50 ppm water, based in each case on the mass.

A methylpolysiloxane mixture according to the invention can be produced by preparing, mixing and metering addition of methylpolysiloxanes Siₓ or D_{y} or any mixtures of such methylpolysiloxanes to one another in any sequence, optionally also repeating multiple times, optionally also alternately or simultaneously. By means of suitable methods, for example distillation, methylpolysiloxanes or methylpolysiloxane mixtures can also be removed again. The composition of the methylpolysiloxane mixture according to the invention is controlled in this case by the amounts of methylpolysiloxanes Siₓ and D_{y} used or removed.

The method can be carried out at room temperature and atmospheric pressure, but also at elevated or reduced temperature and elevated or reduced pressure.

Methylpolysiloxane mixtures according to the invention can also be prepared by hydrolyzing or co-hydrolyzing suitable chlorosilanes, alkoxysilanes or mixtures of chlorosilanes or alkoxysilanes and then by freeing them of by-products such as chlorohydrocarbons or alcohols and also, if necessary, excess water. Optionally, further methylpolysiloxanes can be added to the resulting methylpolysiloxane mixture or can be removed by suitable methods, for example, distillation. The method can be carried out at room temperature and atmospheric pressure, but also at elevated or reduced temperature and elevated or reduced pressure. The composition of the methylpolysiloxane mixture according to the invention is controlled in this case by the ratio of the amounts of silanes or methylpolysiloxanes used and optionally removed again.

Methylpolysiloxane mixtures according to the invention can also be prepared by heating pure methylpolysiloxanes Siₓ and D_{y} or any mixtures of such methylpolysiloxanes to temperatures at which the rearrangement processes mentioned take place, such that methylpolysiloxane mixtures with a modified composition are obtained. This composition may correspond to the equilibrium composition at this temperature, but this does not have to be so. The heating may be carried out in an open or closed system, preferably under a protective gas atmosphere. The method can be carried out at atmospheric pressure but also at elevated or reduced pressure. The heating may be carried out uncatalyzed or in the presence of a homogeneous or heterogeneous catalyst, for example an acid or base. The catalyst can then be deactivated or can be removed from the siloxane mixture, by distillation or filtration for example, but this does not have to be so. Methylpolysiloxanes or methylpolysiloxane mixtures can also be removed again by suitable methods, for example distillation. The composition of the methylpolysiloxane mixture according to the invention is controlled in this case by the ratio of the amounts of methylpolysiloxanes Siₓ and D_{y} used and optionally removed again, the temperature and type (open or closed system) and duration of heating.

The three methods described above can also be combined. They can optionally be carried out in the presence of one or more solvents. Preferably, no solvent is used. The silanes, silane mixtures, methylpolysiloxanes and methylpolysiloxane mixtures used are either standard products of the silicon industry or can be prepared by synthetic methods known from the literature.

The methylpolysiloxane mixtures according to the invention may comprise dissolved or suspended or emulsified additives in order to increase their stability or to influence their physical properties. Dissolved metal compounds, for example iron carboxylates, as radical scavengers and oxidation inhibitors, can increase the service life of a heat carrier. Suspended additives, for example carbon or iron oxide, can improve the physical properties of a heat carrier, for example the heat capacity or the thermal conductivity.

Preferably, in the methylpolysiloxane mixture, the sum total of the proportions of all methylpolysiloxanes Siₓ and D_{y} is at least 95% by mass, more preferably at least 98% by mass, and especially at least 99.5% by mass, based on the total mixture.

The methylpolysiloxane mixture according to the invention can be used as a heat transfer fluid, preferably as a heat transfer fluid for high temperatures (HTF), particularly in solar thermal devices, especially in parabolic trough and Fresnel power plants. They can also be used as heat transfer fluids in the chemical, pharmaceutical, foodstuff and also the metal industry and as working fluids in power plants, especially solar thermal power plants. The methylpolysiloxane mixture is preferably used at temperatures of 350° C. to 500° C., more preferably 380° C. to 450° C., and especially 400° C. to 430° C. At temperatures above 200° C., use under a protective gas atmosphere is preferred in order to prevent oxidative decomposition.

### EXAMPLES

### Equilibration of the Methylpolysiloxane Mixtures:

Under thermal stress, linear endstopped methylpolysiloxanes rearrange (equilibrate). Irrespective of the starting composition, the result is a methylpolysiloxans mixture which is in thermal thermodynamic equilibrium. The thermal equilibrium position results from the maximum operating temperature to which the methylpolysiloxane is exposed, and the molar M:D ratio (M: Me₃SiO_{1/2} chain end groups; D: Me₂SiO_{2/2} chain extension units) of the methylpolysiloxane mixture. In order to obtain methylpolysiloxane mixtures having a composition comparable to CSP power plant operation, 150 g of methylpolysiloxane mixtures having a defined molar M:D ratio in each case were weighed into 250 ml steel ampoules under a nitrogen atmosphere, which were degassed (3×20 mbar, 3 minutes each time) and sealed under an argon atmosphere (1 bar). The steel ampoules were subsequently stored at 425° C. for 2 months in order to reach thermodynamic equilibrium of the methylpolysiloxane mixtures existing at 425° C. The M to D ratio does not change as a result (²⁹Si-NMR). The molecular composition of the methylpolysiloxane mixtures, on the contrary, already have (equilibration). The methylpolysiloxane mixtures thus obtained were used for further investigation (GPC, GC, heat capacity measurement).

### Composition of the Methylpolysiloxane Mixtures:

### Gel Permeation Chromatography (GPC)

The composition of the methylpolysiloxane mixtures was determined by GPC. Instrument Iso Pump Agilent 1200, autosampler Agilent 1200, column oven Agilent 1260 detector, RID Agilent 1200, column Agilent 300×7.5 mm OligoPore exclusion 4500D, column material highly crosslinked polystyrene/divinylbenzene, eluent toluene, flow rate 0.7 ml/min, injection volumes 10 μl, concentration 1 g/l (in toluene), PDMS (polydimethylsiloxane) calibration (Mp 28500 D Mp 25200 D, Mp 10500 D, Mp 5100 D, Mp 4160 D, Mp 1110 D, Mp 311D). Evaluation in area percent.

### Gas Chromatography (GC)

The composition of the methylpolysiloxane mixtures was determined by GC. Instrument Varian GC-3900 gas chromatograph, column VF-200 ms 30 m×0.32 mm×0.25 μm, carrier gas helium, flow rate 1 ml/min, injector CP-1177, split 1:50, detector FID 39×1 250° C. Evaluation in area percent. Calibration has shown that the area percent correspond to mass percent.

The composition of the methylpolysiloxane mixtures was determined by a combination of GPC and GC data. Since Si2 and D3, Si3 and D4, Si4 and D5, Si5 and D6, Si6 and D7, Si7 and D8 and Si8 and D9 in GPC appear in each case as one peak, the ratio of the respective compounds was determined and taken into account by GC. As a result, the content of Si2-Si8 and D3-D8 can be determined. All high boilers from Si9 and from D9 are specified together as “Siₓ(x>8)+D_{y} (y>8)”. Siₓ are linear methylpolysiloxanes, D_{y} are cyclic methylpolysiloxanes. Data in area percent. Calibration has shown that area percent correspond to mass percent.

Measurement of the M to D ratio (²⁹Si-NMR) The proportion of M (Me₃SiO_{1/2} chain ends) and D groups (-Me₂Si0_{2/2} chain links) was determined by nuclear magnetic resonance spectroscopy (²⁹Si-NMR; Bruker Avance III HD 500 (²⁹Si: 99.4 MHz) spectrometer with BBO 500 MHz S2 probe; inverse gated pulse sequence (NS=3000); 150 mg of methylpolysiloxane mixtures in 500 μl of a 4×10⁻² molar solution of Cr(acac)₃ in CD₂Cl₂.

### Heat Capacity:

The heat capacity was determined by dynamic differential scanning calorimetry (DSC) using the SENSYS evo instrument from SETARAM. The heat capacity was determined by the step method in 5-10° C. steps from 25° C. to 450° C. From the methylpolysiloxane mixture to be investigated, 70 mg was weighed out in each case into a 160 μl gold crucible under a nitrogen atmosphere. The pressure formed by heating (autogenous pressure of the methylpolysiloxane mixtures) in the capsules was not detected. The accuracy of the measurements was confirmed by heat capacity determinations of sapphire.

TABLE 3
Mass composition of the methylpolysiloxane mixtures (M:D ratio
from NMR; Si2—Siₓ and D3—D_{y} content by GC/GPC):

| M:D = 1:y | 4.00 | 5.80 | 8.99 |
|---|---|---|---|
| Si2 | 2.1 | 1.2 | 0.8 |
| D3 | 2.0 | 2.1 | 2.5 |
| Si3 | 3.8 | 2.1 | 1.3 |
| D4 | 10.3 | 11.6 | 12.6 |
| Si4 | 6.0 | 3.4 | 2.1 |
| D5 | 6.2 | 7.7 | 9.0 |
| Si5 | 7.1 | 4.3 | 3.0 |
| D6 | 2.0 | 2.8 | 3.5 |
| Si6 | 6.6 | 4.5 | 3.3 |
| D7 | 0.4 | 0.7 | 1.0 |
| Si7 | 6.0 | 4.3 | 3.3 |
| D8 | 0.1 | 0.2 | 0.3 |
| Si8 | 5.3 | 4.0 | 3.2 |
| Siₓ (x > 8) + | 42.2 | 51.2 | 54.1 |
| D_{y} (y > 8 | | | |

TABLE 4
Heat capacity measurements with limit of the critical point
(decline of the Cp value between bold and normal font):

| | Cp | Cp | Cp |
|---|---|---|---|
| T | M:D = 1:4.00 | M:D = 1:5.80 | M:D = 1:8.99 |
| [° C.] | [kJ/kg*K] | [kJ/kg*K] | [kJ/kg*K] |
| 25 | 1.677 | 1.670 | 1.545 |
| 50 | 1.722 | 1.711 | 1.613 |
| 100 | 1.811 | 1.795 | 1.740 |
| 150 | 1.899 | 1.878 | 1.856 |
| 200 | 1.988 | 1.962 | 1.960 |
| 250 | 2.077 | 2.045 | 2.053 |
| 300 | 2.166 | 2.129 | 2.134 |
| 350 | 2.255 | 2.212 | 2.203 |
| 360 | 2.272 | 2.229 | 2.216 |
| 370 | 2.290 | 2.246 | 2.228 |
| 380 | 2.308 | 2.262 | 2.239 |
| 385 | 2.317 | 2.271 | 2.245 |
| 390 | 2.326 | 2.279 | 2.250 |
| 395 | 2.335 | 2.287 | 2.256 |
| 400 | 2.343 | 2.296 | 2.261 |
| 405 | 2.152 | 2.304 | 2.266 |
| 410 | 2.160 | 2.312 | 2.271 |
| 415 | 2.168 | 2.321 | 2.276 |
| 420 | 2.175 | 2.329 | 2.281 |
| 425 | 2.183 | 2.337 | 2.285 |
| 430 | 2.191 | 2.201 | 2.289 |
| 435 | 2.199 | 2.204 | 2.201 |
| 440 | 2.206 | 2.208 | 2.208 |
| 445 | 2.214 | 2.211 | 2.214 |
| 450 | 2.222 | 2.214 | 2.221 |

The examples show that the transition to the supercritical phase at a molar M:D ratio of 1:4.00 already occurs before the desired operating temperature of 425° C. At a molar M:D ratio from 1:5.80 to 1:8.99, it appears that the transition to the supercritical phase only occurs above 425° C.

1.-9. (canceled)

10. A methylpolysiloxane mixture, comprising methylpolysiloxanes having Me₃Si chain end groups (M) and Me₂SiO units (D), wherein the molar M:D ratio in the methylpolysiloxane mixture is from 1:5.5 to 1:15 and the sum total of the proportions of all cyclic methylpolysiloxanes is 25 to 55% by mass.

11. The mixture of claim 10, in which 35 to 65% by mass of the methylpolysiloxanes in the methylpolysiloxane mixture are selected from methylpolysiloxanes Siₓ where x>8 and D_{y} where y>8.

12. The mixture of claim 10, in which the arithmetic mean of x, weighted by proportions by mass, over all linear methylpolysiloxanes (Siₓ) from Si2 to Si22 is 2.3 to 3.6.

13. The mixture of claim 10, in which the arithmetic mean of y,
weighted by proportions by mass, over all cyclic methylpolysiloxanes (Si_{y}) from D3 to D17 is 1.7 to 3.5.

14. The mixture of claim 10, which has a bimodal, trimodal or multimodal molar mass distribution.

15. The heat transfer fluid, comprising a methylpolysiloxane mixture of claim 9.

16. The heat transfer fluid of claim 14, which is a heat transfer fluid for solar thermal devices.

17. The heat transfer fluid of claim 15, which operates at temperatures of 350° C. to 500° C.
